(19) United States
(12) Patent Application Publication
(10) Pub. No.: US 2026/0356084 A1
(43) Pub. Date: Nov. 12, 2026

(54) Patterned Graphene Transfer Using a UV Printed Ink

(71) Applicant: General Graphene Corp., Knoxville, TN (US)

(72) Inventors: Gregory Hayzen, Knoxville, TN (US); Michael Stanford, Knoxville, TN (US)

(73) Assignee: General Graphene Corp., Knoxville, TN (US)

(21) Appl. No.: 19/674,072

(22) Filed: May 11, 2026

Related U.S. Application Data
(60) Provisional application No. 63/803,740, filed on May 11, 2025.

(51) Int. Cl. B32B 37/00; B32B 9/00; B32B 37/24; B32B 38/00; B32B 38/10

(52) U.S. Cl. CPC B32B 37/025; B32B 9/007; B32B 37/24; B32B 38/10; B32B 38/145; B32B 2037/243; B32B 2037/246; B32B 2307/7376; B32B 2333/12

(57) ABSTRACT

A method for patterning and/or transferring a layered graphene composite. The method includes growing a graphene sheet layer on a top surface of a metal catalyst layer by chemical vapor deposition. A polymer support layer is deposited over the graphene sheet layer. An ink support layer is deposited on a bottom surface of the metal catalyst layer in a desired pattern and/or deposited on a top surface of the polymer support layer. The metal catalyst layer not covered by the ink support layer is etched to form the layered graphene composite. In certain embodiments, the ink support layer is formed of UV-curable monomers and photoinitiators and the step of depositing the ink support layer includes printing and curing the printable ink under ultraviolet light using a UV inkjet printer.

### CROSS REFERENCE TO RELATED APPLICATION

This application claims priority to co-pending U.S. Provisional Application Ser. No. 63/803,740 filed May 11, 2025, entitled “Pattern Graphene Transfer Using a UV Printed Ink,” the entire contents of which is incorporated herein by reference.

### FIELD

This disclosure relates generally to a process for transferring graphene to a target substrate. More particularly, this disclosure relates to a process for transferring graphene grown on a metal catalyst layer to a target substrate in a manner that enhances transfer uniformity and/or enables precise patterning of grown graphene.

### BACKGROUND

Graphene, a two-dimensional (2D) material consisting of a single or few layers of carbon atoms in a hexagonal lattice, offers exceptional electrical, thermal, and mechanical properties, enabling applications in electronics, energy storage, and sensors. Graphene grown via chemical vapor deposition (CVD) on metal catalysts, such as copper, forms a continuous monolayer or few-layer sheet that requires transfer to a target substrate. Traditional wet transfer methods, using a spin-coated support layer like poly(methyl methacrylate) (PMMA) and etching the metal catalyst, often introduce defects such as cracks and folds. Relatedly, patterning graphene into specific shapes typically involves complex lithographic processes that can also damage the material.

What is needed therefore is a process that enhances transfer uniformity and/or enables precise patterning of CVD-grown graphene sheets, distinct from processes for graphene flakes or powders.

### SUMMARY

The present disclosure provides a method for patterning a layered graphene composite including: growing a graphene sheet layer on a top surface of a metal catalyst layer by chemical vapor deposition; depositing a polymer support layer over the graphene sheet layer; depositing an ink support layer on a bottom surface of the metal catalyst layer in a desired pattern; and etching the metal catalyst layer not covered by the desired pattern of the ink support layer to form the layered graphene composite.

According to certain embodiments, the method further includes transferring the layered graphene composite to a target substrate. In some embodiments, the method further includes depositing a second ink support layer on a top surface of the polymer support layer before transferring the layered graphene composite to the target substrate. In some embodiments, the method further includes removing the polymer support layer and the ink support layer leaving the graphene sheet layer on the target substrate.

According to certain embodiments, the graphene sheet layer is a continuous 2D graphene sheet and the metal catalyst layer includes copper foil. In some embodiments, the continuous 2D graphene sheet is between one and three atomic layers thick.

According to certain embodiments, the step of depositing the ink support layer on the bottom surface of the metal catalyst layer includes printing a printable ink on the bottom surface of the metal catalyst layer. In some embodiments, the printable ink of the ink support layer is formed of UV-curable monomers and photoinitiators, and the step of printing the ink support layer includes printing and curing the printable ink under ultraviolet light using a UV inkjet printer.

According to certain embodiments, the step of depositing the polymer support layer includes spin-coating a PMMA support layer over the graphene sheet layer.

According to certain embodiments, the method further includes depositing a second ink support layer on a top surface of the polymer support layer.

According to another embodiment of the disclosure, a method for improving the transfer quality of a layered graphene composite includes growing a graphene sheet layer on a top surface of a metal catalyst layer by chemical vapor deposition; depositing a polymer support layer over the graphene sheet layer; depositing an ink support layer on a top surface of the polymer support layer; and etching the metal catalyst layer to form the layered graphene composite.

According to certain embodiments, the method further includes transferring the layered graphene composite to a target substrate. In some embodiments, the method further includes removing the polymer support layer and the ink support layer to leave the graphene sheet layer on the target substrate.

According to certain embodiments, the graphene sheet layer is a continuous 2D graphene sheet and the metal catalyst layer includes copper foil.

According to certain embodiments, the continuous 2D graphene sheet is between one and three atomic layers thick.

According to certain embodiments, the step of depositing the ink support layer on the top surface of the polymer support layer includes printing a printable ink on the top surface of the polymer support layer. In some embodiments, the printable ink of the ink support layer is formed of UV-curable monomers and photoinitiators, and the step of printing the ink support layer includes printing and curing the printable ink under ultraviolet light using a UV inkjet printer.

According to certain embodiments, the step of depositing the polymer support layer includes spin-coating a PMMA support layer over the graphene sheet layer.

### BRIEF DESCRIPTION OF THE DRAWINGS

Other embodiments of the disclosure will become apparent by reference to the detailed description in conjunction with the figures, wherein elements may not be to scale so as to more clearly show the details, wherein like reference numbers indicate like elements throughout the several views, and wherein:

FIG. 1 depicts an exemplary process for forming a layered graphene composite optimized for transferring graphene to a target substrate according to one embodiment of the disclosure.

### DETAILED DESCRIPTION

The following description is presented for purposes of illustration and description. It is not intended to be exhaustive or to limit the disclosure to the precise form disclosed. Obvious modifications or variations are possible in light of the following teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure.

The present disclosure relates to a method for transferring and patterning graphene, specifically a monolayer or few-layer continuous sheet produced via chemical vapor deposition (CVD), using a printable ink such as UV-printed ink. The process is designed for 2D graphene grown on a metal catalyst and is not applicable to graphene in flake or powder form. In one embodiment, the ink support layer is applied to the metal catalyst opposite the graphene sheet layer as a mask, enabling selective copper etching that leaves a uniformly suspended graphene/polymer composite in etched areas, facilitating graphene patterning. In another embodiment, the ink support layer is applied atop the polymer support layer to maintain uniform tension during transferring of the composite to a target substrate. Both methods preferably leverage UV printing precision and ink durability to improve patterning and transfer quality for 2D graphene sheets, excluding flake or powder forms.

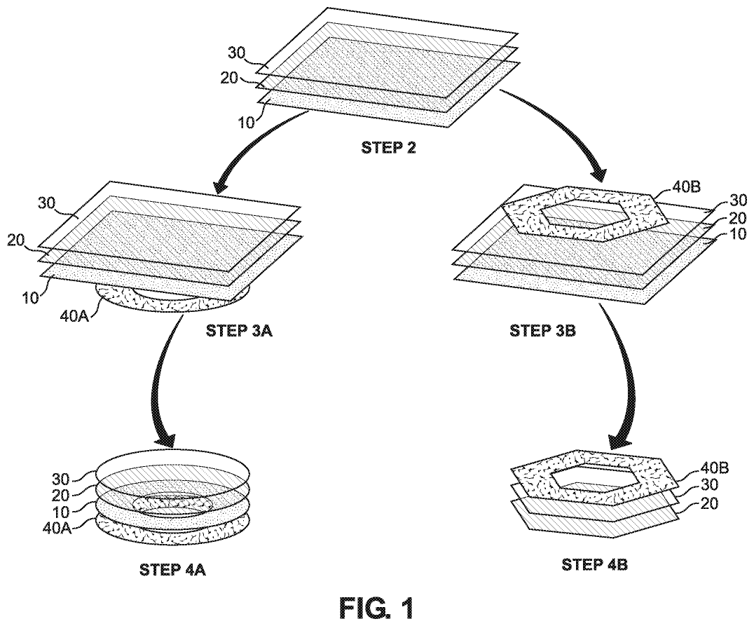

The steps of an exemplary method according to the present disclosure are provided below and illustrated in FIG. 1 (the illustration of FIG. 1 begins at step two).

In step one, a monolayer or few-layer graphene sheet 20 layer (1 to 3 atomic layers thick) is grown on a metal catalyst layer 10, preferably copper foil, using a CVD process. This involves exposing the metal catalyst layer 10 to a carbon-containing gas (e.g., methane) at approximately 1000 °C under controlled conditions, forming a continuous graphene sheet layer 20 on the metal catalyst layer 10. Example of apparatuses and associated processes for growing graphene according to step one is described in U.S. Pat. Nos. 11,858,813 and 10,533,264, the contents of which are incorporated herein by reference in their entireties.

With reference to FIG. 1, in Step 2, a polymer support layer 30, preferably spin-coated PMMA, is deposited onto the graphene sheet layer 20 (the side facing away from metal catalyst 10) according to methods as known in the art, forming a uniform polymer film approximately 200-500 nm thick. This polymer support layer 30 supports the graphene of the graphene sheet layer 20 during etching and transfer. While the support layer 30 is described herein as preferably being a spin-coated PMMA layer, it should be understood that other processable polymers may be utilized within the scope of the present disclosure to act as the support layer 30 for the graphene sheet layer 20 grown on the metal catalyst layer 10.

With continued reference to FIG. 1, in Step 3A, an ink support layer 40A is deposited to the metal catalyst layer 10 opposite the graphene sheet layer 20 in a desired pattern using an inkjet printer. The ink of ink support layer 40A is preferably composed of UV-curable monomers and photoinitiators such that it is operable to be cured under ultraviolet light by a UV inkjet printer. Thus, the ink support layer 40A forms a chemically resistant mask over the metal catalyst layer 10 in the desired pattern. While the printable ink is described herein as preferably a UV-curable ink, it should be understood that other printable inks may be utilized within the scope of the present disclosure such as visible-light-curable inks, thermal curable inks, and two-component epoxy or acrylic inks.

In Step 3B, to enhance transfer uniformity, an ink support layer 40B is deposited atop the polymer support layer 30 in a desired pattern or in a continuous layer. Similar to ink support layer 40A, the ink of ink support layer 40B is preferably composed of UV-curable monomers and photoinitiators such that it is operable to be cured under ultraviolet light by a UV inkjet printer. Ink support layer 40B reinforces the polymer support layer 30 and graphene sheet layer composite (e.g., PMMA-graphene composite) for maintaining uniform tension during wet transfer and minimizing cracks and folds.

According to certain embodiments, Step 3B is performed in addition to Step 3A. In other words, in certain embodiments, ink support layer 40A is deposited to the metal catalyst layer 10 according to Step 3A while ink support layer 40B is also deposited to the polymer support layer 30 according to Step 3B. In other embodiments, Step 3B is performed with Step 3A being omitted.

In Step 4A and Step 4B, the metal from the portions of the metal catalyst layer 10 not covered by the ink support layer 40A, 40B is etched using an etchant (e.g., ferric chloride or ammonium persulfate), leaving the graphene intact in those areas and forming a layered graphene composite structure. For example, when etching following Step 3A, the layered graphene composite structure includes the polymer support layer 30 and graphene sheet layer 20 uniformly suspended on top of the etched metal catalyst layer 10 that has taken the same pattern as the ink support layer 40A as shown in Step 4A. On the other hand, when etching following Step 3B, the metal catalyst layer 10 is fully removed (assuming Step 3A was omitted) as there is no ink support layer 40B protecting the metal catalyst layer 10 from the etchant. Thus, as shown in Step 4B, the layered graphene composite structure includes the polymer support layer 30 and graphene sheet layer 20 uniformly suspended to the ink patterned ink support layer 40B.

Following etching, the remaining layered graphene composite structure is scooped from the solution onto a target substrate (e.g., silicon dioxide, glass, or polyethylene terephthalate (PET)) according to methods as known in the art. The composite is dried, ensuring adhesion to the substrate. In certain embodiments, the polymer support layer 30 and ink support layer 40A and/or 40B are then dissolved using a solvent (e.g., acetone) leaving the graphene sheet layer 20 on the target substrate. The graphene sheet layer 20 exhibits minimal defects due to the uniform suspension during patterning or tension maintenance during transfer.

In certain applications, it may be desirable for the layered graphene composite structure to be used as-is (i.e., without removal of the support layers 30, 40A, and/or 40B from the graphene sheet layer 20) whether following its application to the target substrate or as a freestanding application (i.e., without transferring to a target substrate). For example, a layered graphene composite structure including polyesterimide as the polymer support layer 30 may be utilized to form an ultrathin transducer for audio related applications where the printable ink provides additional support to the composite.

In one exemplary embodiment, the preferred materials for the various layers and/or method steps are as follows. The metal catalyst layer 10 is formed of a copper foil approximately 25 μm thick. The polymer support layer 30 is PMMA, molecular weight 950K, dissolved in anisole, spin-coated at 2000-4000 rpm. The ink support layer 40A and/or 40B is a UV-curable ink (e.g., acrylate-based formulations). The etchant used in Step 4A and Step 4B is ferric chloride (0.5 M aqueous solution). The layered graphene composite is then transferred to a target substrate selected from the group consisting of a silicon or silicon dioxide wafer, glass, and PET.

In summary, the method and materials disclosed herein preferably enables precise graphene patterning by selectively etching the metal catalyst layer through an ink support layer, leaving a suspended graphene and polymer support layer that preserves the desired pattern of the graphene prior to transfer to a target substrate. Additionally, methods disclosed herein improves transfer quality by maintaining tension between a CVD-grown 2D graphene sheet and polymer support layer using a printable ink. Enhancing/simplifying patterning of graphene on a target substrate would have many benefits, particularly in flexible electronic applications.

What is claimed is:

1. A method for patterning a layered graphene composite, the method comprising:
growing a graphene sheet layer on a top surface of a metal catalyst layer by chemical vapor deposition;
depositing a polymer support layer over the graphene sheet layer;
depositing an ink support layer on a bottom surface of the metal catalyst layer in a desired pattern; and
etching the metal catalyst layer not covered by the desired pattern of the ink support layer to form the layered graphene composite.

2. The method of claim 1 further comprising transferring the layered graphene composite to a target substrate.

3. The method of claim 2 further comprising depositing a second ink support layer on a top surface of the polymer support layer before transferring the layered graphene composite to the target substrate.

4. The method of claim 2 further comprising removing the polymer support layer and the ink support layer leaving the graphene sheet layer on the target substrate.

5. The method of claim 1 wherein the graphene sheet layer is a continuous 2D graphene sheet and the metal catalyst layer includes copper foil.

6. The method of claim 5 wherein the continuous 2D graphene sheet is between one and three atomic layers thick.

7. The method of claim 1 wherein the step of depositing the ink support layer on the bottom surface of the metal catalyst layer includes printing a printable ink on the bottom surface of the metal catalyst layer.

8. The method of claim 7 wherein the printable ink of the ink support layer is formed of UV-curable monomers and photoinitiators, and wherein the step of printing the ink support layer includes printing and curing the printable ink under ultraviolet light using a UV inkjet printer.

9. The method of claim 1 wherein the step of depositing the polymer support layer includes spin-coating a PMMA support layer over the graphene sheet layer.

10. The method of claim 1 further comprising depositing a second ink support layer on a top surface of the polymer support layer.

11. A method for improving the transfer quality of a layered graphene composite, the method comprising:
growing a graphene sheet layer on a top surface of a metal catalyst layer by chemical vapor deposition;
depositing a polymer support layer over the graphene sheet layer;
depositing an ink support layer on a top surface of the polymer support layer; and
etching the metal catalyst layer to form the layered graphene composite.

12. The method of claim 11 further comprising transferring the layered graphene composite to a target substrate.

13. The method of claim 12 further comprising removing the polymer support layer and the ink support layer to leave the graphene sheet layer on the target substrate.

14. The method of claim 11 wherein the graphene sheet layer is a continuous 2D graphene sheet and the metal catalyst layer includes copper foil.

15. The method of claim 14 wherein the continuous 2D graphene sheet is between one and three atomic layers thick.

16. The method of claim 11 wherein the step of depositing the ink support layer on the top surface of the polymer support layer includes printing a printable ink on the top surface of the polymer support layer.

17. The method of claim 16 wherein the printable ink of the ink support layer is formed of UV-curable monomers and photoinitiators, and wherein the step of printing the ink support layer includes printing and curing the printable ink under ultraviolet light using a UV inkjet printer.

18. The method of claim 11 wherein the step of depositing the polymer support layer includes spin-coating a PMMA support layer over the graphene sheet layer.
